(19) United States
(12) Patent Application Publication
(10) Pub. No.: US 2005/0100042 A1
(43) Pub. Date: May 12, 2005

(54) Method and system to pre-fetch a protocol control block for network packet processing

(76) Inventor: Rameshkumar G. Illikkal, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/712,640

(22) Filed: Nov. 12, 2003

(51) Int. Cl. H04L 12/56

(52) U.S. Cl. 370/463; 370/412

(57) ABSTRACT

A method and system to pre-fetch a protocol control block for network packet processing is described. The method includes receiving a packet, pre-fetching a protocol control block (PCB) associated with the packet into a cache, queuing the packet for processing, and retrieving the PCB from the cache when a processing unit is ready to process the packet.

### BACKGROUND

1. Technical Field

Embodiments of the invention relate to the field of network packet processing, and more specifically to pre-fetching a protocol control block for network packet processing.

2. Background Information and Description of Related Art

When a packet arrives at a network device, the network interface card (NIC) takes the packet and stores it in a main memory. The NIC may then send an interrupt to notify the central processing unit (CPU) about the packet. An interrupt unit may then check the destination of the interrupt, disable further interrupts from the NIC, initiate a software interrupt, and queue the packet for processing. When the processing unit is ready to process the packet, the connection to which the packet belongs is identified. This may involve fetching a Protocol Control Block (PCB) associated with the packet. After the PCB is fetched, the CPU may start processing the packet. The memory latency that occurs from fetching the PCB when the processing unit is ready to process the packet decreases the performance of the network device. As networking speeds increase, this memory latency becomes an increasing problem for performance and throughput.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is a block diagram illustrating an exemplary system incorporating the invention according to one embodiment of the invention.

FIG. 3 is a flow diagram illustrating a method according to an embodiment of the invention.

FIG. 4 is a block diagram illustrating a suitable computing environment in which certain aspects of the illustrated invention may be practiced.

### DETAILED DESCRIPTION

Embodiments of a system and method to pre-fetch a protocol control block for network packet processing are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

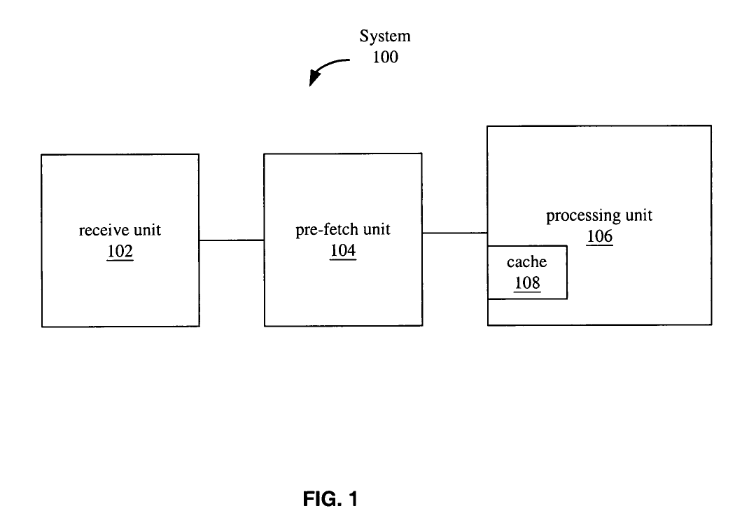

Referring to FIG. 1, a block diagram illustrates a system 100 according to one embodiment of the invention. Those of ordinary skill in the art will appreciate that the system 100 may include more components than those shown in FIG. 1. However, it is not necessary that all of these generally conventional components be shown in order to disclose an illustrative embodiment for practicing the invention.

System 100 includes a receive unit 102 to receive packets from a network. In one embodiment, the packets may be communicated in accordance with the Transmission Control Protocol (TCP/IP) specification. A particular series of packets may be referred to as a “connection” or “packet flow.” The context of a connection may be stored in a structure/known as a Protocol Control Block (PCB). This context may be uniquely identified by the connection's source IP address, destination IP address, source port, destination port, and/or protocol type. For each packet received at receive unit 102, the PCB associated with the packet may need to be retrieved from memory.

Accessing the PCB from the memory for each packet sent and received has associated memory latency and bandwidth issues. To reduce these issues, a pre-fetch unit 104 fetches the PCB associated with a received packet into a cache 108 of a processing unit 106. The packet is then queued for processing. When the processing unit 106 is ready to process the packet, the PCB may be retrieved from its cache 108. Thus, the memory latency in fetching the PCB when the processing unit is ready to process the packet is reduced.

In one embodiment, the pre-fetch unit 104 also pre-fetches packet header information into the cache 108. When the processing unit 106 is ready to process the packet, the packet's header information may be retrieved from the cache 108 and the packet may then be processed.

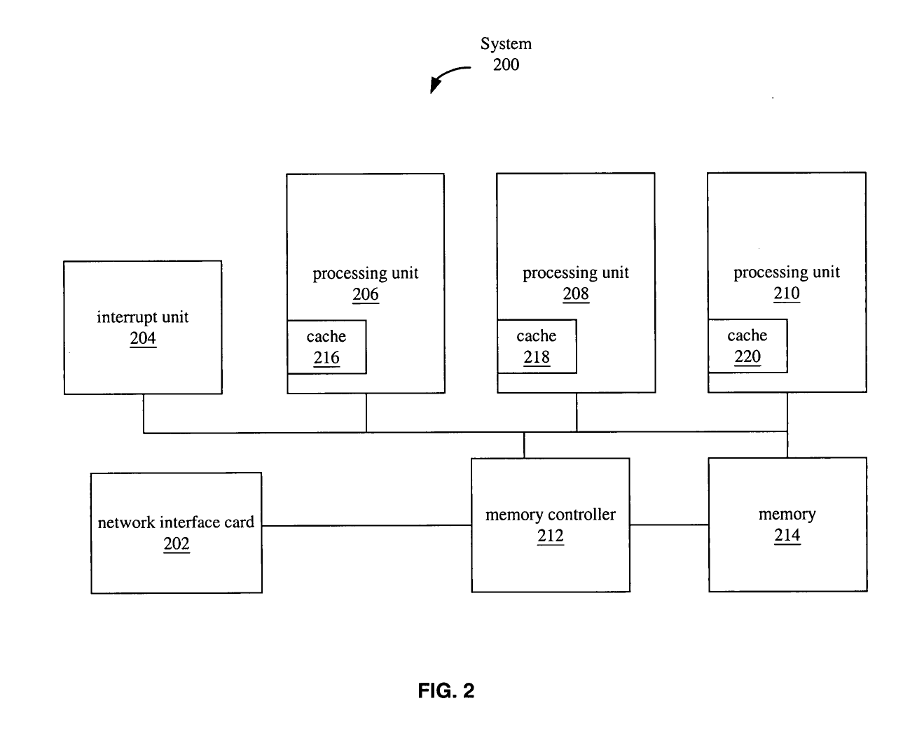

FIG. 2 illustrates an exemplary system incorporating the invention according to one embodiment of the invention. In this embodiment, a network interface card (NIC) 202 receives packets from a network. The packet is stored in a main memory 214 through memory controller 212. The NIC 202 sends an interrupt to notify a processing unit, such as 206, 208, or 210, about the packet. An interrupt unit 204, such as an interrupt service rotate (ISR) unit, checks the destination of the interrupt, disables further interrupts from the NIC, initiates a software interrupt, and queues the packet for processing. In one embodiment, the packet is queued for processing by queuing a deferred procedure call (DPC). At this time, a pre-fetch of the PCB associated with the packet may be initiated. A pre-fetch of a packet header may also be initiated. The PCB and packet header may be pre-fetched into a cache, such as 216, 218, or 220. The pre-fetch may be done in hardware or software. When a processing unit, such as 206, 208, or 210, is ready to process the packet, the processing unit may fetch the PCB and packet header from its cache. Then, the packet may be processed. The processing unit may then enable interrupts from the NIC.

In one embodiment, pre-fetching may also be used on the send side to reduce memory latency. When a packet is queued for transmission out of the network, the PCB may be pre-fetched. There is usually some delay between the socket interface in the user space and the protocol stack processing in the kernel space. Therefore, when a send request is initiated for a packet, the PCB associated with the packet may be pre-fetched. When the kernel is ready to process the packet for transmission, the PCB has already been pre-fetched and is ready for processing. This reduces the memory latency on the send side.

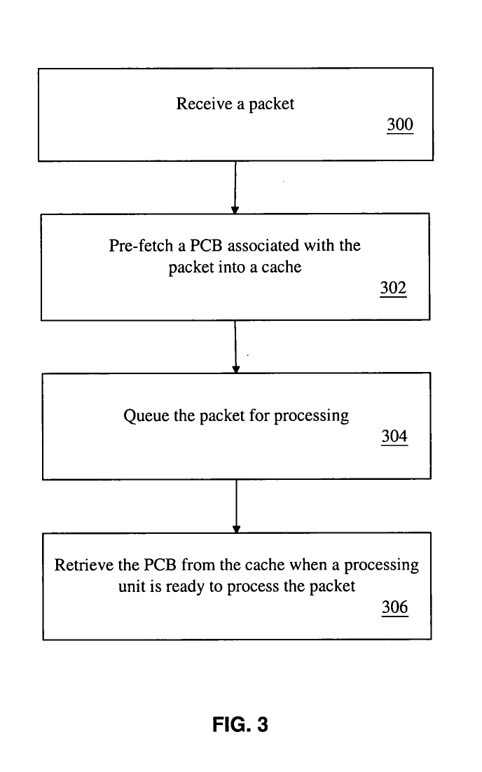

FIG. 3 illustrates a method according to one embodiment of the invention. At 300, a packet is received. At 302, a PCB associated with the packet is pre-fetched into a cache. In one embodiment, a packet header is also pre-fetched into the cache. At 304, the packet is queued for processing. At 306, when a processing unit is ready to process the packet, the PCB is retrieved from the cache. In one embodiment, the packet's header is also retrieved from the cache. Then, the packet may be processed.

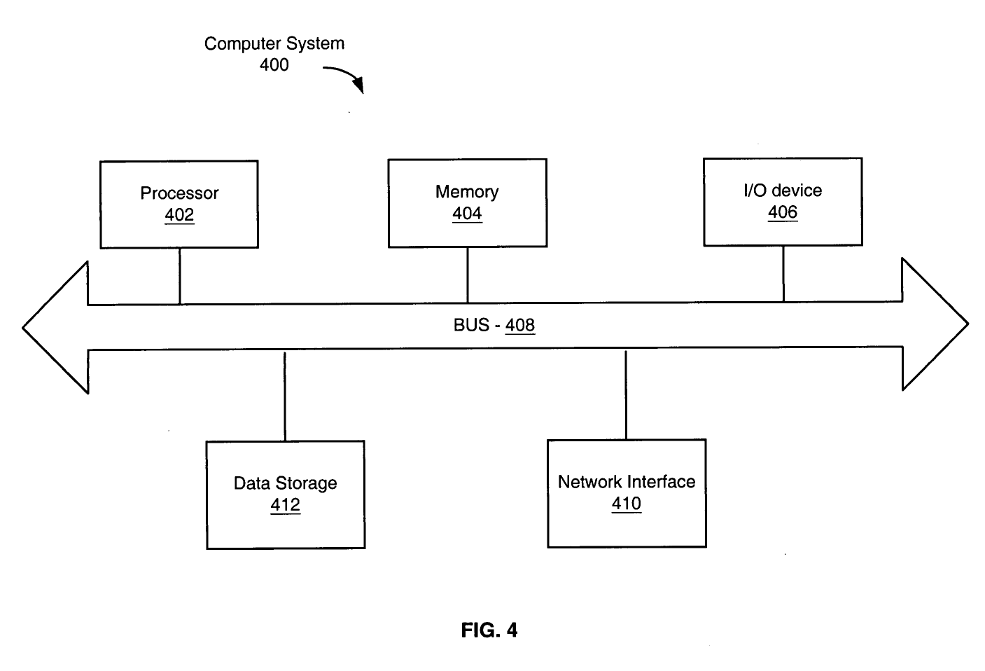

FIG. 4 is a block diagram illustrating a suitable computing environment in which certain aspects of the illustrated invention may be practiced. In one embodiment, the method described above may be implemented on a computer system 400 having components 402-412, including a processor 402, a memory 404, an Input/Output device 406, a data storage device 412, and a network interface 410, coupled to each other via a bus 408. The components perform their conventional functions known in the art and provide the means for implementing the system 100. Collectively, these components represent a broad category of hardware systems, including but not limited to general purpose computer systems and specialized packet forwarding devices. It is to be appreciated that various components of computer system 400 may be rearranged, and that certain implementations of the present invention may not require nor include all of the above components. Furthermore, additional components may be included in system 400, such as additional processors (e.g., a digital signal processor), storage devices, memories, and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
receiving a packet at a network device;
pre-fetching a protocol control block (PCB) associated with the packet into a cache;
queuing the packet for processing; and
retrieving the PCB from the cache when a processing unit is ready to process the packet.

2. The method of claim 1, further comprising pre-fetching a header associated with the packet into the cache.

3. The method of claim 2, further comprising retrieving the packet header from the cache when the processing unit is ready to process the packet.

4. The method of claim 1, further comprising sending an interrupt to notify the processing unit of the receipt of the packet.

5. The method of claim 1, wherein pre-fetching a PCB associated with the packet into a cache comprises pre-fetching a PCB associated with the packet into a cache of the processing unit.

6. The method of claim 5, further comprising storing the packet in a memory coupled to the processing unit.

7. The method of claim 1, further comprising processing the packet.

8. An apparatus comprising:
a receive unit to receive a packet;
a pre-fetch unit coupled to the receive unit to pre-fetch a protocol control block (PCB) associated with the packet into a cache and queue the packet for processing; and
a processing unit coupled to the pre-fetch Unit to retrieve the PCB from the cache and process the packet.

9. The apparatus of claim 8, wherein the receive unit is a network interface card.

10. The apparatus of claim 8, wherein the pre-fetch unit to further pre-fetch a header associated with the packet into the cache.

11. The apparatus of claim 10, wherein the processing unit to further retrieve the packet header from the cache.

12. The apparatus of claim 8, wherein the pre-fetch unit to pre-fetch a PCB associated with the packet into a cache comprises the pre-fetch unit to pre-fetch a PCB associated with the packet into a cache of the processing unit.

13. The apparatus of claim 8, further comprising an interrupt unit coupled to the receive unit and the processing unit to receive an interrupt from the receive unit and notify the processing unit of the packet.

14. An article of manufacture comprising:
a machine accessible medium including content that when accessed by a machine causes the machine to:
receive a packet;
pre-fetch a protocol control block (PCB) associated with the packet into a cache;
queue the packet for processing; and
retrieve the PCB from the cache when a processing unit is ready to process the packet.

15. The article of manufacture of claim 14, wherein the machine-accessible medium further includes content that causes the machine to pre-fetch a header associated with the packet into the cache.

16. The article of manufacture of claim 15, wherein the machine-accessible medium further includes content that causes the machine to retrieve the packet header from the cache when the processing unit is ready to process the packet.

17. The article of manufacture of claim 14, wherein the machine-accessible medium further includes content that causes the machine to process the packet.

18. The article of manufacture of claim 14, wherein the machine-accessible medium further includes content that causes the machine to send an interrupt to notify the processing unit of the receipt of the packet.

19. The article of manufacture of claim 14, wherein the machine accessible medium including content that when accessed by the machine causes the machine to pre-fetch a PCB associated with the packet into a cache comprises the machine accessible medium including content that when accessed by the machine causes the machine to pre-fetch a PCB associated with the packet into a cache of the processing unit.

20. The article of manufacture of claim 14, wherein the machine-accessible medium further includes content that causes the machine to store the packet in a memory coupled to the processing unit.

21. A system comprising:
a receive unit to receive a packet;
a memory coupled to the receive unit to store the received packet;
a memory controller coupled to the memory to manage the memory;
a pre-fetch unit coupled to the receive unit to pre-fetch a protocol control block (PCB) associated with the packet into a cache and queue the packet for processing; and
a processing unit to retrieve the PCB from the cache and process the packet.

22. The system of claim 21, wherein the receive unit is a network interface card.

23. The system of claim 21, wherein the pre-fetch unit to further pre-fetch a header associated with the packet into the cache.

24. The system of claim 23, wherein the processing unit to further retrieve the packet header from the cache.

25. The system of claim 21, further comprising an interrupt unit coupled to the receive unit and the processing unit to receive an interrupt from the receive unit and notify the processing unit of the packet.
